(19) United States
(12) Patent Application Publication
(10) Pub. No.: US 2020/0074480 A1
(43) Pub. Date: Mar. 5, 2020

(54) MACHINE LEARNING BASELINE OPTIMIZATION SYSTEM

(71) Applicant: Opendoor Labs Inc., San Francisco, CA (US)

(72) Inventors: Leonid Boris Pekelis, San Francisco, CA (US); Jackson Christopher Gorham, San Francisco, CA (US)

(21) Appl. No.: 16/122,839

(22) Filed: Sep. 5, 2018

(51) Int. Cl. G06Q 30/02; G06F 15/18; G06F 17/11; G06F 7/58

(52) U.S. Cl. CPC G06Q 30/0201; G06F 7/588; G06F 17/11; G06F 15/18

(57) ABSTRACT

Systems and methods for machine learning to adjust a baseline model are provided. In example embodiments, a networked system determines an initial value for each of a plurality of homes. The networked system applies a baseline model to each initial value to generate a baseline value for each of the plurality of homes. A randomization process is performed by the networked system on an input value for each of the plurality of homes to generate a final value for each of the plurality of homes, whereby each input value being based on a corresponding baseline value. Each of the plurality of homes is listed at a corresponding final value. The networked system then analyzes a result of the listing for the plurality of homes. Based on the analyzing, the networked system automatically adjusts the baseline model.

### TECHNICAL FIELD

The subject matter disclosed herein generally relates to special-purpose machines configured to the technical field of optimization systems, and to the technologies by which such special-purpose machines become improved compared to other machines that optimize a baseline model. Specifically, the present disclosure addresses systems and methods to optimize a baseline optimization process using machine learning.

### BACKGROUND

Conventionally, determining a value for a home can be technically challenging based on a variety of factors (e.g., location, features of the home, comparable homes) that can affect a final value for the home. For example, setting the value too high may cause the home to sit on the market for a longer period of time, while setting the value too low can result in loss profit.

### BRIEF DESCRIPTION OF THE DRAWINGS

Some embodiments are illustrated by way of example and not limitation in the figures of the accompanying drawings.

FIG. 1 is a diagram illustrating a network environment suitable for optimizing a baseline model using machine learning, according to some example embodiments.

FIG. 2 is a block diagram illustrating components of a listing system, according to some example embodiments.

FIG. 3 is a block diagram illustrating components of an optimization engine, according to some example embodiments.

FIG. 4 is a flowchart illustrating operations of a method for generating a randomized listing value in order to train the networked system, according to some example embodiments.

FIG. 5 is a flowchart illustrating operations of a method for analyzing results of a randomizing process to automatically adjust a baseline model, according to some example embodiments.

FIG. 6 is a block diagram illustrating components of a machine, according to some example embodiments, able to read instructions from a machine-readable medium and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present disclosure provides technical solutions for optimizing a baseline optimization process using machine learning. When a home is listed, the profit can be generated by moving the value up or down a little bit in order to get an estimate of the supply and demand relationship. While increasing the value slightly may cause the home to sell for more, it may take longer to sell. As such, there is an optimal tradeoff. Using historical data and observational data to predict value may not work because market conditions are constantly changing.

Example embodiments maintain and adjust a baseline model (also referred to herein as the “baseline optimization process”) by introducing randomness to determine a causal estimate of the value at which to list the home. Results of a randomization process are analyzed and used to adjust the baseline model. Thus, example methods (e.g., algorithms) and example systems (e.g., special-purpose machines) are configured to optimize a baseline optimization process using machine learning.

In example embodiments, a networked system determines an initial value for each of a plurality of homes. The networked system applies a baseline model to each initial value to generate a baseline value for each of the plurality of homes. A randomization process is performed by the networked system on an input value for each of the plurality of homes to generate a final value for each of the plurality of homes, whereby each input value is based on a corresponding baseline value. Each of the plurality of homes is listed at a corresponding final value. The networked system then analyzes a result of the listing for the plurality of homes. Based on the analyzing, the networked system automatically adjusts the baseline model.

Therefore, one or more of the methodologies described herein facilitate solving the technical problem of machine learning to optimize a baseline model. By using the example embodiments, users do not need to guess how to generate a value. In some cases, guessing may cause continuous readjustment to the value. Additionally, the continual machine learning allows for optimization of the baseline model based on market conditions and seasonality. Resources used by one or more machines, databases, or devices (e.g., within the environment) may be reduced by reduction of readjustment of values. Examples of such computing resources include processor cycles, network traffic, memory usage, data storage capacity, power consumption, network bandwidth, and cooling capacity.

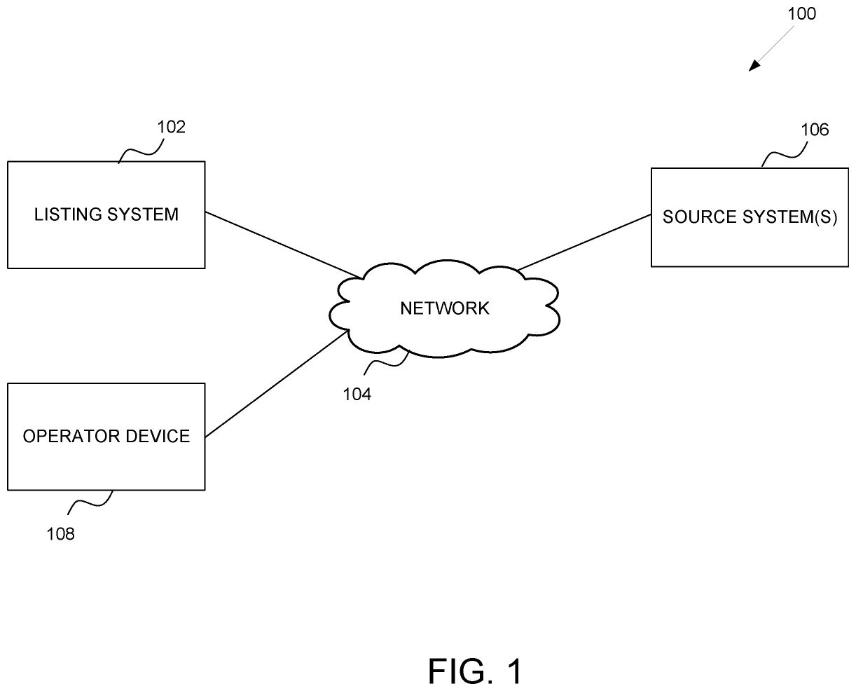

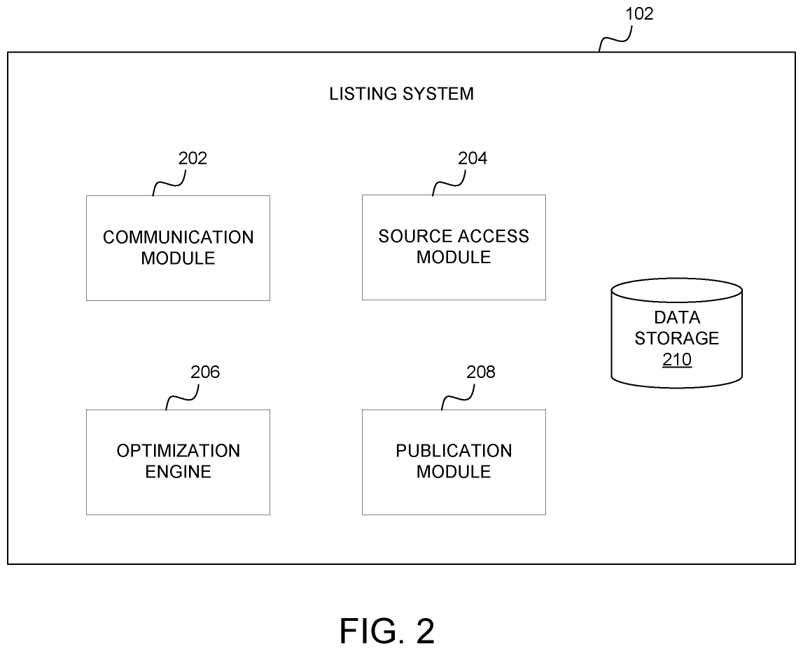

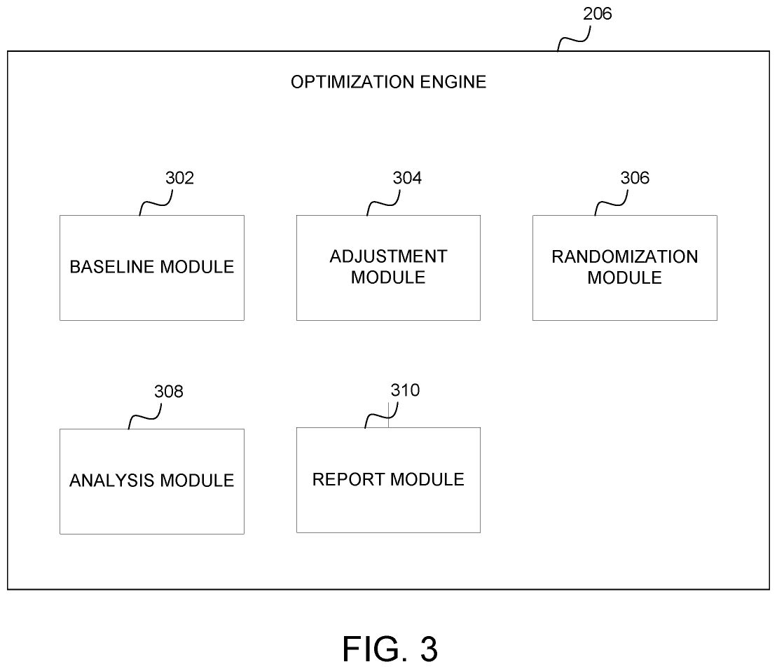

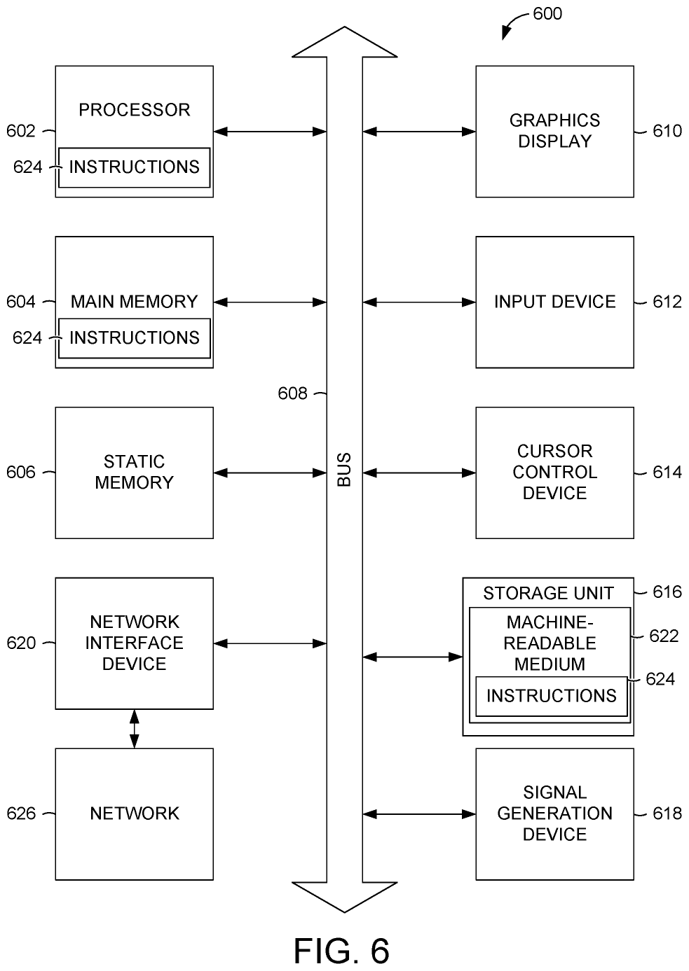

FIG. 1 is a diagram illustrating a network environment 100 suitable for optimizing a baseline optimization process using machine learning, according to some example embodiments. The network environment 100 includes a listing system 102 (e.g., a networked system) communicatively coupled via a network 104 to one or more source systems 106 and an operator device 108. In example embodiments, the listing system 102 comprises components that performs a baseline optimization process, adjusts and randomizes values, and analyzes the results of the randomization in order to adjust the baseline optimization process. The components of the listing system 102 are described in more detail in connection with FIG. 2 and FIG. 3, and may be implemented in a computer system, as described below with respect to FIG. 6.

The components of FIG. 1 are communicatively coupled via the network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, a satellite network, a cable network, a broadcast network, another type of network, or a combination of two or more such networks. Any one or more portions of the network 104 may communicate information via a transmission or signal medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

In example embodiments, the one or more source systems 106 (e.g., servers) are associated with third party sources that provide information to the listing system 102 via the network 104. Accordingly, the listing system 102 can access comparable data (e.g., comparable values for similar homes), sales data (e.g., number of sales, sale price), and other information which can affect a value of a home that is being valued by the listing system 102. In some embodiments, the source systems 106 comprise web sites or entities that collect, store, and provide access to home valuation information. In one embodiment, the listing system 102 accesses the home valuation information on the source systems 106 using a web crawler.

The operator device 108 comprises a device of an agent, manager, or employee (collectively referred to herein as “operator”) associated with the listing system 102. Using the operator device, the operation can view valuation information (e.g., baseline value, input value, sales price), but not the randomized value. The operator can also change a baseline value using the operator device 108. For example, if the operator, having local knowledge of the real estate market, determines that the baseline value generated by the listing system 102 is not accurate, the operator can adjust the baseline value.

In example embodiments, any of the systems, machines, databases, or devices (collectively referred to as “components”) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 6, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined into a single component, and the functions described herein for any single component may be subdivided among multiple components. Additionally, any number of listing systems 102, source systems 104, and operator devices 108 may be embodied within the network environment 100. Furthermore, some components or functions of the network environment 100 may be combined or located elsewhere in the network environment 100. For example, some of the functions of the listing system 102 may be embodied within the operator device 108 or vice-versa.

FIG. 2 is a block diagram illustrating components of the listing system 102, according to some example embodiments. In various embodiments, the listing system 102 performs a baseline optimization process to determine a baseline value, adjusts and randomizes values, and analyzes the results of the randomization in order to adjust the baseline model. To enable these operations, the listing system 102 comprises a communication module 202, a source access module 204, an optimization engine 206, a publication module 208, and a data storage 210. The listing system 102 may also comprise other components (not shown) that are not pertinent to example embodiments. Furthermore, any one or more of the components of FIG. 2 (e.g., modules, storage) described herein may be implemented using hardware (e.g., a processor of a machine) or a combination of hardware and software. Moreover, any two or more of these components of FIG. 2 may be combined into a single component, and the functions described herein for a single component may be subdivided among multiple components.

In example embodiments, the communication module 202 is configured to receive listing information. Listing information comprises, for example, address of a home, square footage, number of rooms and types of room, and/or one or more images of the home. In some embodiments, the listing information is provided by the operator device 108. In other embodiments, the listing information is received from users of the listing system 102 such as a seller of a home.

The source access module 204 manages access (e.g., retrieving, receiving) to information from the source systems 106. In example embodiments, the source access module 204 accesses comparable data (e.g., comparable values for similar homes in the same neighborhood or area), sales data (e.g., number of sales, sale price), and other information which can affect a value of a home that is being valued by the listing system 102. The listing information as well as comparable information accessed from the source system 106 may be stored to the data storage 210 in some embodiments.

The optimization engine 206 manages the baseline optimization process, operator adjustments to a baseline value generated by the baseline optimization process, a randomization process, and analysis of the randomization. The analysis of the randomization is then used to machine train the baseline optimization process (e.g., adjust the baseline model). Because market conditions frequently change (e.g., vary monthly or seasonally), the optimization engine 206 performs the machine training continuously (e.g., as sales data resulting from the randomization process is received) or periodically (e.g., batch mode once a week or once a month). The optimization engine 206 will be discussed in more detail in connection with FIG. 3 below.

The publication module 208 publishes (e.g., lists) a home for sale at a final value after the randomization process. For example, the publication module 208 may create a webpage dedicated to the home and providing information about the home including images of the home. In some embodiments, the publication module 208 may also publish information about the home to other real estate sites.

FIG. 3 is a block diagram illustrating components of the optimization engine 206, according to some example embodiments. In various embodiments, the optimization engine 206 manages the baseline optimization process, operator adjustments to a baseline value generated by the baseline optimization process, the randomization process, and analysis of the randomization. The analysis of the randomization is then used to machine train the baseline optimization process (e.g., adjust the baseline model). To enable these operations, the optimization engine 206 comprises a baseline module 302, an adjustment module 304, a randomization module 308, an analysis module 308, and a report module 310 all configured to communicate with each other (e.g., via a bus, shared memory, or a switch). The optimization engine 206 may also comprise other components (not shown) that are not pertinent to example embodiments. Furthermore, any one or more of the components of FIG. 3 (e.g., modules) described herein may be implemented using hardware (e.g., a processor of a machine) or a combination of hardware and software. Moreover, any two or more of these components of FIG. 3 may be combined into a single component, and the functions described herein for a single component may be subdivided among multiple components.

The baseline module 302 is configured to perform the baseline optimization process. In example embodiments, the baseline module 302 examines a plurality of information to determine a baseline value for a home. For example, the baseline module 302 takes the home information provided by a seller and accesses the comparable information for similar homes in the same area from the source systems 106 (e.g., directly from the source system 106 or from the data storage 210). Using the comparable information, the baseline module 302 generates an initial value for the home. The initial value is a value that the listing system 102 thinks the home should sell at. For example, an initial value generated for a home may be $100,000.

Once the initial value is generated, the baseline module 302 marks up the initial value by applying a machine-learned markup amount derived for the baseline model. Thus, the baseline model includes a current machine-learned markup amount. A markup is an amount that is applied to a valuation of what the home may be worth or may sell for. For example, a home may be marked up 5-7% (or other amount) over what the home may be worth (e.g., initially valued at). Because the baseline module 302 (e.g., the baseline model or baseline optimization process) is continually/periodically machine trained, the machine-learned markup amount may be adjusted periodically (e.g., monthly or seasonally). For example, a machine-learned markup amount is increased in the spring because spring is a time period where homes sales are higher and/or selling at a higher price. Continuing with the example, the initial value (e.g., $100,000) is marked up by a current machine-learned markup amount (e.g., 5%) resulting in a baseline value (e.g., $105,000).

In example embodiments, the adjustment module 304 is configured to adjust the baseline value. In some cases, an operator that is familiar with a market in which the home is located determines that the baseline value is off (e.g., too high, too low). As such, the operator, via the operator device 108, transmits instructions to adjust the baseline value. The adjustment module 304 receives the instructions and makes the adjustment to the baseline value resulting in an adjusted value.

The randomization module 306 manages the randomization process at the listing system 102. In example embodiments, the randomization module 306 takes the adjust value or the baseline value if no adjustment was made by the adjustment module 304 (collectively referred to herein as “input value”) and randomly decides whether to apply a randomization factor (e.g., add the randomization factor, subtract the randomization factor) to the input value or do nothing to the input value. In one embodiment, the randomization module 306 applies a randomization factor of 1% (e.g., add 1% or subtract 1%), although any percentage or amount (e.g., dollar amount) may be used. Alternatively, the randomization factor is a rounding factor (e.g., a rounding up or rounding down) applied to the input value (e.g., to a nearest $1,000). Further still, the randomization module 306 can use a combination of randomization factors. For example, the randomization can be based on a combination of percentage (or amount) and rounding. Thus, the randomization module 306 may, for example, add 1% to the input value, subtract 1% from the input value, or do nothing to the input value. The result of the randomization process is a final value at which the home will be listed by the publication module 208.

The analysis module 308 analyzes the results of the listing of the homes at a corresponding final value for a particular period of time for a particular market or area. In example embodiments, the analysis module 308 compares the price for which each home actually sold to the final value for which each home was listed. The analysis may indicate, for example, that the final value was too high, too low, or just right or whether homes that were randomized took longer to sell. Generally speaking, randomizing the input prices up/down has a tradeoff. For example, if one randomizes up, the home will take longer to sell, but it may net a higher final close price and vice versa for randomizing down. Based on the results of the analysis (e.g., for a plurality of homes sold within the particular period of time), the analysis module 308 may instruct the baseline module 302 to adjust the baseline model (e.g., adjust the machine-learned markup amount).

For example, if the results show that homes randomized with an additional randomization factor of 1% sold at a higher value than their final value out-weighting the decrease in rate of selling than homes randomized with a subtraction of 1% or without any change in the input price, then the analysis module 308 may instruct the baseline module 302 to adjust the baseline model by increasing the machine-learned markup amount. For instance, if the initial machine-learned markup amount is 5%, the baseline module 302 changes the machine-learned markup amount to 5.5% (e.g., increase of 0.5% from the initial 5%). Conversely, if the results show that homes randomized with a subtraction of 1% sold faster out-weighting the decrease in value than homes randomized with an addition of 1% or without any change in the input price, then the analysis module 308 may instruct the baseline module 302 to adjust the baseline model by decreasing the machine-learned markup amount. For instance, if the initial machine-learned markup amount is 5%, the baseline module 302 changes the machine-learned markup amount to 4.5% (e.g., decrease of 0.5% from the initial 5%).

Further still, the analysis may be contextual, with contexts defined via information from the communication module 202, the source access module 204, or the data storage 210. For example, if the results show an additional randomization factor of 1% increased profit more than homes randomized with a subtraction of 1% or without any change in input price, in the context of homes with initial value below $200,000, then the analysis module 308 may instruct the baseline module 302 to increase the machine-learned markup amount only for homes with initial value below $200,000. These contexts may be chosen exogenously. For example, the optimization engine 206 is designed to choose different machine-learned markup amounts for different initial values. The contexts may be endogenously machine-learned as well. For example, the analysis module 308 incorporates many possible contexts (e.g., price point, geo-location, seasonality, and comparables), and then filters out contexts with low change in profit across the randomization factors. In some embodiments, filtering of contexts is implemented in the analysis module 308 via Bayesian hierarchical regression.

It is noted that the adjustment amount (e.g., 0.5%) made to the machine-learned markup amount is just an example and the adjustment amount may be any percentage, dollar amount, or rounding factor (e.g., to a nearest $100, $1000, or 10,000). In some embodiments, the analysis module 308 determines the adjustment amount. For example, if the results of the analysis show that the price difference for homes that sold above the final value was equivalent to 1%, then the analysis module 308 may instruct the baseline module 302 to increase the machine-learned markup amount by 1%.

In example embodiments, the increase in machine-learned markup amount balances signal (e.g., homes with an additional randomization factor of 1% performed better) and uncertainty. For example, if there is high disparity in individual home improvements (e.g., some homes with randomization factor sold at higher value and some did not), then the change in machine-learned markup amount will be less than if there is low disparity (e.g., all homes with randomization factor sold at higher value). For instance, the machine-learned markup amount is changed to 5.25% (e.g., increase of 0.25% from the initial 5%) if the results show high disparity, and the machine-learned markup amount is changed to 5.5% (e.g., increase of 0.5% from the initial 5%) if the results show low disparity. Balance of signal and uncertainty may be implemented by solving for the change in the machine-learned markup amount to maximize the expected log of generated wealth, in accordance with the Kelly criterion (e.g., a formula used to determine an optimal size of a series of items in order to maximize the logarithm of wealth).

The report module 310 is configured to generate and provide reports regarding the analysis performed by the analysis module 308. In example embodiments, the reports are provided to the operator at the operator device 108. The operator may be a manager or employee of the listing system 102.

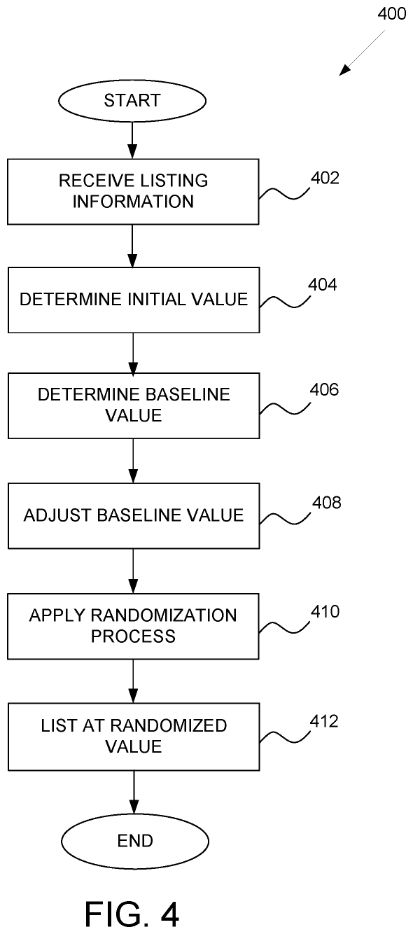

FIG. 4 is a flowchart illustrating operations of a method 400 for generating a randomized listing value in order to train the networked system (e.g., the listing system 102), according to some example embodiments. Operations in the method 400 may be performed by the listing system 102, using components described above with respect to FIG. 2. Accordingly, the method 400 is described by way of example with reference to the listing system 102. However, it shall be appreciated that at least some of the operations of the method 400 may be deployed on various other hardware configurations or be performed by similar components residing elsewhere in the network environment 100. Therefore, the method 400 is not intended to be limited to the listing system 102.

In operation 402, the communication module 202 receive listing information. The listing information comprises, for example, address of a home, square footage, number of rooms and types of room, and/or one or more images of the home. The listing information may be provided by the operator device 108 or received from users of the listing system 102 such as a seller of the home.

In operation 404, the baseline module 302 determines an initial value for the home. In example embodiments, the baseline module 302 examines a plurality of information to determine a baseline value for a home. For example, the baseline module 302 takes the listing information provided by a seller and accesses the comparable information for similar homes in the same area accessed from the source systems 106 (e.g., by the source access module 204). Using the comparable information, the baseline module 302 generates the initial value for the home. The initial value is a value that the listing system 102 thinks the home should sell for. For example, an initial value generated for a home may be $100,000.

In operation 406, the baseline module 302 determines a baseline value for the home. In example embodiments, the baseline module 302 determines the baseline value based on the baseline model. Accordingly, the baseline module 302 marks up the initial value using a machine-learned markup amount. Because the baseline module 302 (e.g., the baseline model or baseline optimization process) is continually machine trained, the machine-learned markup amount may be adjusted periodically (e.g., monthly or seasonally). For example, a machine-learned markup amount may be increased in the spring because spring is a time period where homes sales are higher, selling at a higher price, and/or selling with less days on the market (e.g., selling faster). Continuing with the example, the initial value (e.g., $100,000) is marked up by the current machine-learned markup amount (e.g., 5%) resulting in the baseline value (e.g., $105,000).

In operation 408, the adjustment module 304 adjusts the baseline value. In some cases, an operator that is familiar with a market in which the home is located determines that the baseline value is off (e.g., too high, too low). In these cases, the operator transmits instructions to adjust the baseline value via the operator device 108 to the adjustment module 304. The adjustment module 304 receives the instructions and makes the adjustment to the baseline value resulting in an adjusted value. Operation 408 is optional. Thus, in some cases, there is no adjustment to the baseline value.

In operation 410, the randomization module 306 applies a randomization process to the input value (e.g., the adjusted value or the baseline value if no adjustment is made in operation 408). In example embodiments, the randomization module 306 randomly decides whether to apply a randomization factor (e.g., increase value by the randomization factor, subtract value by the randomization factor) or do nothing to the input value. In one embodiment, the randomization factor applied by the randomization module 306 is 1% (e.g., increase value by 1%, decrease value by 1%), although any percentage or amount (e.g., dollar amount) may be used. Alternatively, the randomization may be a rounding up or rounding down of the input value (e.g., to a nearest $1,000). Thus, the randomization module 306 may, for example, randomly add 1% to the input value, randomly subtract 1% from the input value, or do nothing to the input value.

The result of the randomization process is a final value at which the home will be listed by the publication module 208 in operation 412. The final value is also stored to the data storage 210 and later used by the analysis module 308.

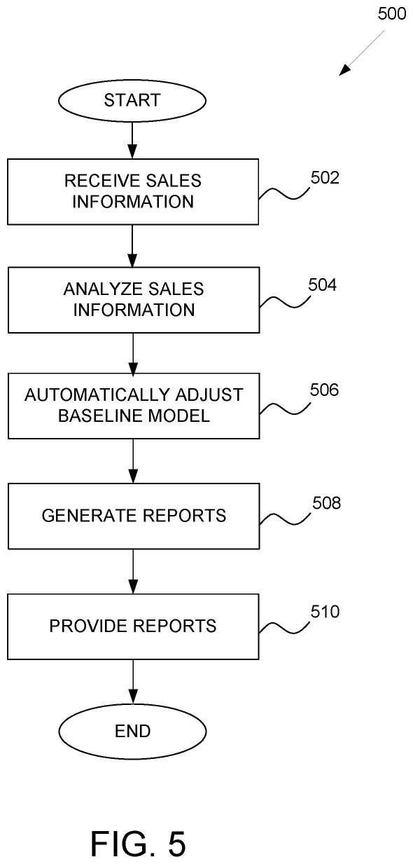

FIG. 5 is a flowchart illustrating operations of a method 500 for analyzing results of a randomizing process to automatically adjust a baseline model, according to some example embodiments. Operations in the method 500 may be performed by the optimization engine 206, using components described above with respect to FIG. 3. Accordingly, the method 500 is described by way of example with reference to the optimization engine 206. However, it shall be appreciated that at least some of the operations of the method 500 may be deployed on various other hardware configurations or be performed by similar components residing elsewhere in the network environment 100. Therefore, the method 500 is not intended to be limited to the optimization engine 206.

In operation 502, the analysis module 308 accesses sales information for a plurality of homes for a particular market/area. The area may comprise, for example, a neighborhood, a zip code, or a city. The sales information includes a value at which each home sold.

In operation 504, the analysis module 308 analyzes the sales information. In example embodiments, the analysis module 308 compares the price for which each home actually sold versus the final value for which each home was listed. The analysis also looks at the amount of time each home took to sell. The analysis may indicate, for example, that the final value was too high, too low, or just right, or that a randomization to the initial price affected a length of time each home took to sell.

Based on the result of the analysis (e.g., for a plurality of homes sold within the particular period of time), the analysis module 308 may instruct the baseline module 302 to automatically adjust the baseline model (e.g., adjust the machine-learned markup amount) in operation 506. For example, if the results show that homes randomized with an additional 1% sold faster and/or at a higher value than their final value than homes randomized with a subtraction of 1% or without any change in the input price, then the analysis module 308 may instruct the baseline module 302 to increase the machine-learned markup amount. Conversely, if the results show that homes randomized with a subtraction of 1% sold faster and/or at a higher value than their final value than homes randomized with an addition of 1% or without any change in the input price, then the analysis module 308 may instruct the baseline module 302 to decrease the machine-learned markup amount.

In operation 508, the report module 310 generates one or more reports regarding the analysis performed by the analysis module 308. The reports are provided to the operator at the operator device 108 in operation 510. The operator may be a general manager of a market, region, or area or other employee(s) of the listing system 102. For example, the general manager may use the report to decide how to change an overall pricing policy for their market. The providing of the report can comprise causing presentation of report information via a user interface on the operator device 108.

While example embodiments discuss adjusting the baseline model (e.g., automatically adjusting the machine-learned markup amount) based on a market (e.g., a city, a region), alternative embodiments may apply the baseline model and condition adjustment of the baseline model based on other categories. For example, homes can be categorized into high price homes and low price homes. Thus, high price homes may have a machine-learned markup amount that is different than low price homes.

Furthermore, while example embodiments discuss adjusting the baseline model by adjusting the machine-learned markup amount, alternative embodiments can, alternatively or in addition, determine how fast to adjust the listed value of a home (e.g., drop 1% every 2 weeks). In these embodiments, the randomization process of the randomization module 306 may randomize price adjustments at different times. The sale results for these randomizations are then analyzed by the analysis module 308 and used to adjust a price adjustment process (e.g., how often to adjust and/or what amount to adjust by).

FIG. 6 illustrates components of a machine 600, according to some example embodiments, that is able to read instructions from a machine-readable medium or machine-storage medium and perform any one or more of the methodologies discussed herein. Specifically, FIG. 6 shows a diagrammatic representation of the machine 600 in the example form of a computer device (e.g., a computer) and within which instructions 624 (e.g., software, a program, an application, an applet, an app, or other executable code) for causing the machine 600 to perform any one or more of the methodologies discussed herein may be executed, in whole or in part.

For example, the instructions 624 may cause the machine 600 to execute the flow diagrams of FIG. 4 and FIG. 5. In one embodiment, the instructions 624 can transform the general, non-programmed machine 600 into a particular machine (e.g., specially configured machine) programmed to carry out the described and illustrated functions in the manner described.

In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624 (sequentially or otherwise) that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more modules (e.g., software modules) described herein.

The machine 600 may further include a graphics display 610 (e.g., a plasma display panel (PDP), a light emitting diode (LED) display, a liquid crystal display (LCD), a projector, or a cathode ray tube (CRT), or any other display capable of displaying graphics or video). The machine 600 may also include an alphanumeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a sound card, an amplifier, a speaker, a headphone jack, or any suitable combination thereof), and a network interface device 620.

The storage unit 616 includes a machine-readable medium 622 (e.g., a tangible machine-readable storage medium) on which is stored the instructions 624 (e.g., software) embodying any one or more of the methodologies or functions described herein. The instructions 624 may also reside, completely or at least partially, within the main memory 604, within the processor 602 (e.g., within the processor's cache memory), or both, before or during execution thereof by the machine 600. Accordingly, the main memory 604 and the processor 602 may be considered as machine-readable media (e.g., tangible and non-transitory machine-readable media). The instructions 624 may be transmitted or received over a network 626 via the network interface device 620.

In some example embodiments, the machine 600 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (i.e., 604, 606, and/or memory of the processor(s) 602) and/or storage unit 616 may store one or more sets of instructions and data structures (e.g., software) 624 embodying or utilized by any one or more of the methodologies or functions described herein. These instructions, when executed by processor(s) 602 cause various operations to implement the disclosed embodiments.

As used herein, the terms “machine-storage medium,” “device-storage medium,” “computer-storage medium” (referred to collectively as “machine-storage medium 622”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 622 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 622 specifically exclude carrier waves, modulated data signals, transitory signals, and other such media, at least some of which are covered under the term “signal medium” discussed below. In this sense, a machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 624 may further be transmitted or received over a communications network 626 using a transmission medium via the network interface device 620 and utilizing any one of a number of well-known transfer protocols (e.g., HTTP). Examples of communication networks 626 include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 624 for execution by the machine 600, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

### EXAMPLES

Example 1 is a method for machine learning to adjust a baseline model. The method comprises determining, by a networked system, an initial value for each of a plurality of homes; applying, by the networked system, a baseline model to each initial value to generate a baseline value for each of the plurality of homes; performing, by a processor of the networked system, a randomization process on an input value for each of the plurality of homes to generate a final value for each of the plurality of homes, each input value being based on a corresponding baseline value; listing each of the plurality of homes at a corresponding final value; analyzing, by the networked system, a result of the listing for the plurality of homes; and based on the analyzing, automatically adjusting, by the networked system, the baseline model.

In example 2, the subject matter of example 1 can optionally include receiving instructions to adjust the baseline value; and in response to receiving the instructions, adjusting the baseline value to generate an adjusted value, wherein the input value is the adjusted value.

In example 3, the subject matter of examples 1-2 can optionally include wherein the input value is the baseline value.

In example 4, the subject matter of examples 1-3 can optionally include generating a report based on the analyzing; and causing presentation of the report to an operator associated with the networked system.

In example 5, the subject matter of examples 1-4 can optionally include wherein the randomization process comprises one of increasing the input value by a first randomization factor, decreasing the input value by a second randomization factor, or not changing the input value.

In example 6, the subject matter of examples 1-5 can optionally include wherein the first randomization factor and the second randomization factor is one or more of a percentage, an amount, or a rounding factor.

In example 7, the subject matter of examples 1-6 can optionally include wherein the applying the baseline model comprises applying a machine-learned markup amount to each initial value.

In example 8, the subject matter of examples 1-7 can optionally include wherein the automatically adjusting the baseline model comprises increasing a machine-learned markup amount applied to each initial value based on the analyzing indicated that homes randomized with an addition of a first randomization factor sold faster or at a higher value than their final value than homes randomized with a subtraction of a second randomization factor or homes without any change in the input price.

In example 9, the subject matter of examples 1-8 can optionally include wherein the automatically adjusting the baseline model comprises decreasing a machine-learned markup amount applied to each initial value based on the analyzing indicated that homes randomized with a subtraction of a first randomization factor sold faster or at a higher value than their final value than homes randomized with an addition of a second randomization factor or homes without any change in the input price.

In example 10, the subject matter of examples 1-9 can optionally include periodically repeating the determining, applying, performing, listing, analyzing, and automatically adjusting to account for market conditions.

In example 11, the subject matter of examples 1-10 can optionally include wherein the automatically adjusting the baseline model is contextual based on one or more of price point, geo-location, seasonality, or comparables.

In example 12, the subject matter of examples 1-11 can optionally include determining a machine-learned markup amount with which to adjust the baseline model by balancing signal and uncertainty.

Example 13 is a system for machine learning to adjust a baseline model. The system includes one or more processors and a memory storing instructions that, when executed by the one or more hardware processors, causes the one or more hardware processors to perform operations comprising determining an initial value for each of a plurality of homes; applying a baseline model to each initial value to generate a baseline value for each of the plurality of homes; performing a randomization process on an input value for each of the plurality of homes to generate a final value for each of the plurality of homes, each input value being based on a corresponding baseline value; listing each of the plurality of homes at a corresponding final value; analyzing a result of the listing for the plurality of homes; and based on the analyzing, automatically adjusting the baseline model.

In example 14, the subject matter of example 13 can optionally include wherein the operations further comprise receiving instructions to adjust the baseline value; and in response to receiving the instructions, adjusting the baseline value to generate an adjusted value, wherein the input value is the adjusted value.

In example 15, the subject matter of examples 13-14 can optionally include wherein the input value is the baseline value.

In example 16, the subject matter of examples 13-15 can optionally include wherein the randomization process comprises one of increasing the input value by a first randomization factor, decreasing the input value by a second randomization factor, or not changing the input value.

In example 17, the subject matter of examples 13-16 can optionally include wherein the applying the baseline model comprises applying a machine-learned markup amount to each initial value.

In example 18, the subject matter of examples 13-17 can optionally include wherein the automatically adjusting the baseline model comprises increasing a machine-learned markup amount applied to each initial value based on the analyzing indicated that homes randomized with an addition of a first randomization factor sold faster or at a higher value than their final value than homes randomized with a subtraction of a second randomization factor or homes without any change in the input price.

In example 19, the subject matter of examples 13-18 can optionally include wherein the automatically adjusting the baseline model comprises decreasing a machine-learned markup amount applied to each initial value based on the analyzing indicated that homes randomized with a subtraction of a first randomization factor sold faster or at a higher value than their final value than homes randomized with an addition of a second randomization factor or homes without any change in the input price.

Example 20 is a machine-storage medium for machine learning to adjust a baseline model. The machine-storage medium configures one or more processors to perform operations comprising determining an initial value for each of a plurality of homes; applying a baseline model to each initial value to generate a baseline value for each of the plurality of homes; performing a randomization process on an input value for each of the plurality of homes to generate a final value for each of the plurality of homes, each input value being based on a corresponding baseline value; listing each of the plurality of homes at a corresponding final value; analyzing a result of the listing for the plurality of homes; and based on the analyzing, automatically adjusting the baseline model.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
determining, by a networked system, an initial value for each of a plurality of homes;
applying, by the networked system, a baseline model to each initial value to generate a baseline value for each of the plurality of homes;
performing, by a processor of the networked system, a randomization process on an input value for each of the plurality of homes to generate a final value for each of the plurality of homes, each input value being based on a corresponding baseline value;
listing each of the plurality of homes at a corresponding final value;
analyzing, by the networked system, a result of the listing for the plurality of homes; and
based on the analyzing, automatically adjusting, by the networked system, the baseline model.

2. The method of claim 1, further comprising:
receiving instructions to adjust the baseline value; and
in response to receiving the instructions, adjusting the baseline value to generate an adjusted value, wherein the input value is the adjusted value.

3. The method of claim 1, wherein the input value is the baseline value.

4. The method of claim 1, further comprising:
generating a report based on the analyzing; and
causing presentation of the report to an operator associated with the networked system.

5. The method of claim 1, wherein the randomization process comprises one of increasing the input value by a first randomization factor, decreasing the input value by a second randomization factor, or not changing the input value.

6. The method of claim 5, wherein each of the first randomization factor and the second randomization factor is one or more of percentage, an amount, or a rounding factor.

7. The method of claim 1, wherein the applying the baseline model comprises applying a machine-learned markup amount to each initial value.

8. The method of claim 1, wherein the automatically adjusting the baseline model comprises increasing a machine-learned markup amount applied to each initial value based on the analyzing indicating that homes randomized with an addition of a first randomization factor sold faster or at a higher value than their final value than homes randomized with a subtraction of a second randomization factor or homes without any change in the input price.

9. The method of claim 1, wherein the automatically adjusting the baseline model comprises decreasing a machine-learned markup amount applied to each initial value based on the analyzing indicating that homes randomized with a subtraction of a first randomization factor sold faster or at a higher value than their final value than homes randomized with an addition of a second randomization factor or homes without any change in the input price.

10. The method of claim 1, further comprising periodically repeating the determining, applying, performing, listing, analyzing, and automatically adjusting to account for market conditions.

11. The method of claim 1, wherein the automatically adjusting the baseline model is contextual based on one or more of price point, geo-location, seasonality, or comparables.

12. The method of claim 1, further comprising determining a machine-learned markup amount with which to adjust the baseline model by balancing signal and uncertainty.

13. A system comprising:
one or more hardware processors; and
a memory storing instructions that, when executed by the one or more hardware processors, causes the one or more hardware processors to perform operations comprising:
determining an initial value for each of a plurality of homes;
applying a baseline model to each initial value to generate a baseline value for each of the plurality of homes;
performing a randomization process on an input value for each of the plurality of homes to generate a final value for each of the plurality of homes, each input value being based on a corresponding baseline value;
listing each of the plurality of homes at a corresponding final value;
analyzing a result of the listing for the plurality of homes; and
based on the analyzing, automatically adjusting the baseline model.

14. The system of claim 13, wherein the operations further comprise:
receiving instructions to adjust the baseline value; and
in response to receiving the instructions, adjusting the baseline value to generate an adjusted value, wherein the input value is the adjusted value.

15. The system of claim 13, wherein the input value is the baseline value.

16. The system of claim 13, wherein the randomization process comprises one of increasing the input value by a first randomization factor, decreasing the input value by a second randomization factor, or not changing the input value.

17. The system of claim 13, wherein the applying the baseline model comprises applying a machine-learned markup amount to each initial value.

18. The system of claim 13, wherein the automatically adjusting the baseline model comprises increasing a machine-learned markup amount applied to each initial value based on the analyzing indicating that homes randomized with an addition of a first randomization factor sold faster or at a higher value than their final value than homes randomized with a subtraction of a second randomization factor or homes without any change in the input price.

19. The system of claim 13, wherein the automatically adjusting the baseline model comprises decreasing a machine-learned markup amount applied to each initial value based on the analyzing indicating that homes randomized with a subtraction of a first randomization factor sold faster or at a higher value than their final value than homes randomized with an addition of a second randomization factor or homes without any change in the input price.

20. A machine-readable medium storing instructions that, when executed by one or more processors of a machine, cause the machine to perform operations comprising:
determining an initial value for each of a plurality of homes;
applying a baseline model to each initial value to generate a baseline value for each of the plurality of homes;
performing a randomization process on an input value for each of the plurality of homes to generate a final value for each of the plurality of homes, each input value being based on a corresponding baseline value;
listing each of the plurality of homes at a corresponding final value;
analyzing a result of the listing for the plurality of homes; and
based on the analyzing, automatically adjusting the baseline model.
